(19) United States
(12) Patent Application Publication
(10) Pub. No.: US 2009/0303230 A1
(43) Pub. Date: Dec. 10, 2009

(54) Surface parameterization method

(76) Inventors: Jimin Liu, Singapore (SG); Su Huang, Singapore (SG); Jenice Fung, Singapore (SG); Wieslaw Lucjan Nowinski, Singapore (SG)

Correspondence Address: WOOD, PHILLIPS, KATZ, CLARK & MORTIMER, 500 W. MADISON STREET, SUITE 3800, CHICAGO, IL, 60661, US

(21) Appl. No.: 11/919,771

(22) PCT Filed: Jan. 20, 2006
(86) PCT No.: PCT/SG2006/000011

§ 371 Date: Feb. 23, 2009

Related U.S. Application Data
(60) Provisional application No. 60/676,723, filed on May 2, 2005.

(51) Int. Cl. G06T 15/00; G06T 11/20

(52) U.S. Cl. 345/419; 345/441

(57) ABSTRACT

A method (200) for performing surface parameterization using a divide and conquer strategy is disclosed herein. In one embodiment, a surface is divided into two arbitrary parts (220). Each divided part is separately flattened into a triangular region in parameter space to form first and second disks, respectively (230). The method then combines the first and second disks to form a sphere (240). The final step remeshes the sphere with a predetermined resolution to provide a multi resolution structured surface model for said surface (250).

### CROSS-REFERENCE TO RELATED PATENT APPLICATIONS

This application claims the right of priority under 35 U.S.C. § 119 based on U.S. Provisional Patent Application No. 60/676,723, filed 2 May 2005, which is incorporated by reference herein in its entirety as if fully set forth herein.

### FIELD OF THE INVENTION

The present invention relates generally to geometrical models. In particular, the present invention relates to a method and apparatus for surface parameterization, and to a computer program product including a computer readable medium having recorded thereon a computer program for surface parameterization.

### BACKGROUND

A surface is a two-dimensional manifold. The simplest surface is the sphere in three-dimensional (3D) space. It is also called a genus 0 surface. A more complex surface is described as having genus k if that surface can be obtained by adding k “handles” to the sphere. For example, a torus is a sphere with one handle, and a double torus is a sphere with two handles. A sphere has genus zero (0). All genus-0 surfaces are essentially sphere-shaped, but may vary in degree of deformity from a regular sphere.

Surface parameterization is a one to one mapping of a given three dimensional (3D) surface, such as the Earth, to another two dimensional (2D) surface, such as a page of an atlas. Surfaces are typically represented by triangular meshes and it is desirable to minimize distortions, such as angle and/or area changes, when mapping a first surface to a second surface.

Surface parameterizations are utilized in many scientific and engineering applications, including computer graphics, computer-aided design, and imaging applications. Several parameterization methods are available. However, existing methods exhibit properties that restrict the applications to which those methods can be applied.

First, surface parameterization usually leads to mathematical problems with orders of complexities that are much higher than the linear relationship to the number of vertices or triangle faces. The high computation cost is usually unbearable in practical applications.

Second, when a three-dimensional (3D) surface is flattened to a two-dimensional (2D) parameter space, it is possible for a large number of points from the 3D surface to be projected into a tiny region in the 2D space. This results in a large degree of inaccuracy when the parameter space is sampled to generate a structured mesh.

### SUMMARY

It is an object of the present invention to overcome substantially, or at least ameliorate, one or more disadvantages of existing methods.

According to a first aspect of the present disclosure, there is provided a method of parameterizing a surface, the method comprising the steps of:

dividing a surface into first and second parts;

flattening the first and second parts to first and second disks, respectively;

combining the first and second disks to form a sphere; and

remeshing the sphere with a predetermined resolution to provide a multi-resolution structured surface model for the surface.

According to a second aspect of the present disclosure, there is provided an apparatus for parameterizing a surface, the apparatus comprising:

a device for dividing a surface into first and second parts;

a device for flattening each of the first and second parts to first and second disks, respectively;

a device for combining the first and second disks to form a sphere; and

a device for remeshing the sphere with a predetermined resolution to provide a multi-resolution structured surface model for the surface.

According to a third aspect of the present disclosure, there is provided a computer program product having a computer readable medium having a computer program recorded therein for parameterizing a surface, the computer program product comprising:

computer program code means for dividing a surface into first and second parts;

computer program code means for flattening each of the first and second parts to first and second disks, respectively;

computer program code means for combining the first and second disks to form a sphere; and

computer program code means for remeshing the sphere with a predetermined resolution to provide a multi-resolution structured surface model for the surface.

According to a fourth aspect of the present disclosure, there is provided a computer program for parameterizing a surface, the program comprising:

code for dividing a surface into first and second parts;

code for flattening each of the first and second parts to first and second disks, respectively; and

code for combining the first and second disks to form a sphere; and

code for remeshing the sphere with a predetermined resolution to provide a multi-resolution structured surface model for the surface.

According to another aspect of the present disclosure, there is provided an apparatus for implementing any one of the aforementioned methods.

According to another aspect of the present disclosure there is provided a computer program product including a computer readable medium having recorded thereon a computer program for implementing any one of the methods described above.

Other aspects of the invention are also disclosed.

### BRIEF DESCRIPTION OF THE DRAWINGS

Some aspects of one or more embodiments of the present invention will now be described with reference to the drawings, in which:

FIG. 1 is a schematic diagram representation of surface parameterization of a triangular mesh in accordance with an embodiment of the invention;

FIG. 2 is an implementation flow diagram of a surface parameterization method in accordance with an embodiment of the invention;

FIG. 3A is a schematic diagram representation of triangular meshes illustrating edge directions;

FIG. 3B is a schematic diagram representation of directional paths;

FIG. 4 is a flow diagram of a procedure CutSurface that performs the functionality of step 220 of FIG. 2;

FIG. 5 is a flow diagram of a procedure DnCParameterize that performs the functionality of step 230 of FIG. 2;

FIG. 6 is a flow diagram of a procedure generateInitialPartition that performs the functionality of step 515 of FIG. 5;

FIG. 7 is a flow diagram of a procedure mainProcess that performs the functionality of step 650 of FIG. 6;

FIG. 8 is a flow diagram of a procedure shouldPartition that performs the functionality of step 540 of FIG. 5;

FIG. 9 is a flow diagram of a procedure Partition that performs the functionality of step 545 of FIG. 5;

FIGS. 10A, 10B and 10C illustrate the partitioning of a 3D surface and its corresponding 2D parameter space;

FIGS. 11A and 11B are 3D computer image representations of the corpus callosum of a human brain;

FIGS. 12A to 12B illustrate the closed 3D surface of the corpus callosum shown in FIG. 11B cut into two open surfaces;

FIGS. 13A, 13B and 13C illustrate an open surface and its corresponding parameter space cut into small patches;

FIGS. 14A to 14F illustrate two parameter disks combined to form a parameter sphere and to generate a geometrical image;

FIGS. 15A to 15D illustrate remeshing of the parameter sphere of FIG. 14F to produce multi-resolution models of the corpus callosum of FIG. 11B; and

FIG. 16 is a schematic block diagram of a general purpose computer upon which arrangements described can be practised.

### DETAILED DESCRIPTION OF THE INVENTION

Where reference is made in any one or more of the accompanying drawings to steps and/or features that have the same reference numerals, those steps and/or features have for the purposes of this description the same function(s) or operation(s), unless the contrary intention appears.

Some portions of the description which follows are explicitly or implicitly presented in terms of algorithms and symbolic representations of operations on data within a computer memory. These algorithmic descriptions and representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that the above and similar terms are to be associated with the appropriate physical quantities and are merely convenient labels applied to these quantities. Unless specifically stated otherwise, and as apparent from the following, it will be appreciated that throughout the present specification, discussions utilizing terms such as “scanning”, “calculating”, “determining”, “replacing”, “generating”, “initializing”, “outputting”, or the like, refer to the action and processes of a computer system, or similar electronic device, that manipulates and transforms data represented as physical (electronic) quantities within the registers and memories of the computer system into other data similarly represented as physical quantities within the computer system memories or registers or other such information storage, transmission or display devices.

The present specification also discloses apparatus for performing the operations of the methods. Such apparatus may be specially constructed for the required purposes, or may comprise a general purpose computer or other device selectively activated or reconfigured by a computer program stored in the computer. The algorithms and displays presented herein are not inherently related to any particular computer or other apparatus. Various general purpose machines may be used with programs in accordance with the teachings herein. Alternatively, the construction of more specialized apparatus to perform the required method steps may be appropriate. The structure of a conventional general purpose computer will appear from the description below.

In addition, the present invention also implicitly discloses a computer program, in that it would be apparent to the person skilled in the art that the individual steps of the preferred method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention. Furthermore, one or more of the steps of the computer program may be performed in parallel rather than sequentially.

Such a computer program may be stored on any computer readable medium. The computer readable medium may include storage devices such as magnetic or optical disks, memory chips, or other storage devices suitable for interfacing with a general purpose computer. The computer readable medium may also include a hard-wired medium such as exemplified in the Internet system, or wireless medium such as exemplified in the GSM mobile telephone system. The computer program when loaded and executed on such a general-purpose computer effectively results in an apparatus that implements the steps of the preferred method.

The principles of the preferred method described herein have general applicability to geometric models. However, for ease of explanation, the steps of the preferred method are described with reference to surface parameterization of a 3D genus-0 surface represented by a triangle mesh. However, it is not intended that the present invention be limited to the described method. For example, the invention may have application to computer-aided design, computer gaming, and medical applications. Such medical applications include, but are not limited to, applications related to neurology.

Three-dimensional (3D) surfaces that belong to genus-0 are topologically equivalent to spheres. In one embodiment, a 3D genus-0 surface is represented by a triangle mesh. The surface is divided arbitrarily into two parts. In a preferred embodiment, a balanced cutting of the surface is utilized to provide two parts that are approximately equal, as determined by the number of triangles in each part. Each of the parts is then flattened separately into a triangular region in a parameter space. Each part is recursively divided into two smaller patches in accordance with predetermined criteria. The predetermined criteria may include, for example, that each patch has an equal number of triangles, or that each patch has equal total area. When the number of triangles within a patch is less than a predetermined number, a shape preserved method is utilized to flatten the patch into a parameter space. Each patch constitutes a triangle with a curved edge, and is mapped into a triangular region in the parameter space.

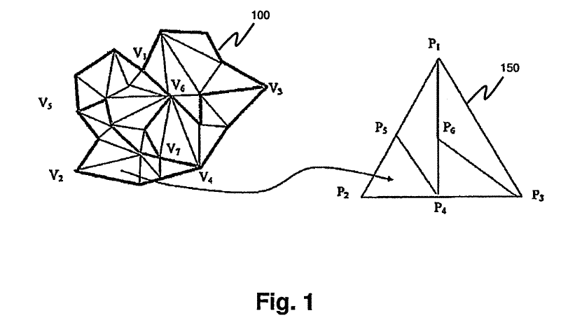

FIG. 1 is a schematic diagram representation of surface parameterization of a triangular mesh 100 to a triangle 150 using a divide and conquer strategy, in accordance with an embodiment of the invention. The triangular mesh 100 represents a 3D surface patch, and is enclosed by bold black boundary edges. The triangular mesh 100 of this example has 13 external vertices on the boundary edges. The initial step is to consider the triangular mesh 100 as a big curved triangle with vertices V₁, V₂, V₃. A first vertex V₁ is selected arbitrarily on the boundary, and second and third vertices V₂ and V₃, respectively, are selected so that there are approximately [n/3] mesh vertices on the curved edges V₁V₂ and V₁V₃, where n is the total number of vertices on the bold boundary. In this example, n=13, so [n/3] is approximately 4. V₂ and V₃ are selected such that there are 4 vertices on the curved edge V₁V₂, 3 vertices on the curved edge V₁V₃, and 3 vertices on the curved edge V₂V₃. Thus, the three vertices V₁, V₂, and V₃ defining the big curved triangle are approximately equally spaced around the boundary of the triangular mesh 100. A fourth vertex V₄ is located on the curved edge V₂V₃, and a fifth vertex V₅ is located on the curved edge V₁V₂. Sixth and seventh vertices V₆ and V₇, respectively, are located within the triangular mesh 100. The vertices at each end of the curved edges are counted as vertices of the curve. For example, there are 6 vertices on the curved path V₁V₂, by counting V₁ and V₂ and the vertices located therebetween.

The first, second and third vertices V₁, V₂, and V₃ are mapped to first, second and third points P₁, P₂, and P₃, respectively, on the triangle 150. P₁, P₂, and P₃ are the vertices of the triangle 150 that has edges of equal length. Thus, the edges P₁P₂, P₂P₃ and P₁P₃ are equal. The surface parameterization maps uniformly the mesh vertices on curved edges V₁V₅V₂, V₂V₄V₃, and V₃V₁ of the triangular mesh 100 onto the line edges P₁P₂, P₂P₃, and P₃P₁ of the triangle 150. For each curved triangle patch, the number of triangles is determined. If the number of triangles is greater than a predetermined number, a curved edge with the maximum vertex number is determined, and the curved triangle patch is then cut into two curved triangle patches. If three curve edges have the same mesh vertex number, one of the curved edges is selected at random.

For example, select the curved triangle patch V(152431), representing the whole mesh 100, and cut the curved triangle patch V(152431) into two patches V(1524761) and V(167431). The two patches V(1524761) and V(167431) are divided by the cut path V₁V₆V₇V₄, and map respectively onto triangles P₁P₂P₄P₁ and P₁P₃P₄P₁ of the triangle 150. P₄ is the middle point of line segment P₂P₃. Vertices on the cut path V₁V₆V₇V₄ map uniformly onto line P₁P₄. Continuing this procedure, cut patch V(1524761) into patches V(1574761) and V(52475) by cut path V₄V₇V₅. Then, cut patch V(167431) into two patches V(1631) and V(36743) by cut path V₃V₆. The cut paths V₄V₇V₅ and V₃V₆ map uniformly onto lines P₄P₅ and P₃P₆, respectively, where P₅ and P₆ are middle points of line segments P₁P₂ and P₁P₄. The resulting four small patches are sufficiently small and need not be cut further. The resulting four small patches of the triangular mesh 100 map into triangular regions P₂P₄P₅, P₁P₄P₅, P₄P₃P₆, and P₃P₁P₆, respectively, of the triangle 150 by using a shape preserved method. In this example, a patch is deemed to be sufficiently small when the number of triangles contained therein is less than a predetermined number.

For a genus-0 surface, once its two parts have been flattened into respective triangular regions, the two parameterized regions are combined into a sphere to obtain the parameterization of the whole surface. If required, smoothed and multi-resolution meshes of the original surface are generated based on the parameterization.

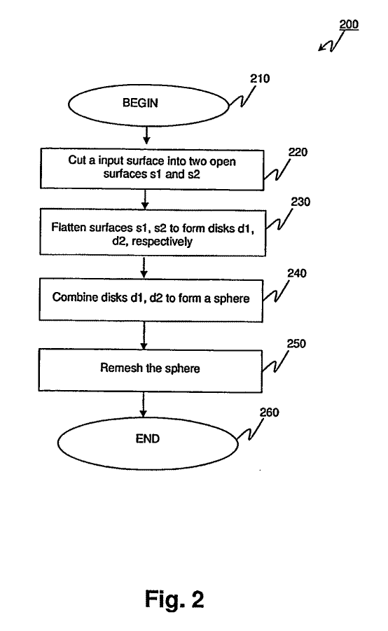

FIG. 2 is an implementation flow diagram of the surface parameterization method 200 in accordance with an embodiment of the invention. The method begins at a BEGIN step 210 and proceeds to step 220 that cuts an input genus-0 surface into two open half surfaces s1 and s2, which share a common boundary b. Step 230 flattens the two open half surfaces s1, s2 to form corresponding disks d1 and d2 respectively. Each of the disks d1, d2 is defined by:

x²+y²≦1 (1)

where x and y are the coordinates of the 2D parameter space. The boundary b is mapped to the circle defined by:

x²+y²=1 (2)

Control passes from step 230 to step 240, which combines the disks d1, d2 to form a sphere defined by:

x²+y²+z²=1 (3)

where z is a coordinate of 3D space obtained by extending the 2D parameter space. The first disk d1 is mapped to:

z=\sqrt{(x²+y²)} (4)

and the second disk d2 is mapped to

z=−\sqrt{(x²+y²)} (5)

where x²+y²≦1.
Control passes to step 250 to remesh the sphere with a given resolution to obtain a related surface model. The remeshing is performed, for example, using the spherical remeshing method described in “Spherical Parameterization and Remeshing”, Praun E. and Hoppe H., ACM SIGRAPH 2003. Control passes to an END step 260 and the method terminates.

In one embodiment, the method 200 of FIG. 2 is implemented using computer program code. Such computer program code can be executed on a general purpose computer or the like. A program parameterizeGenus0 receives the following as input parameters: surface and size. The surface parameter defines an original genus-0 surface. The size parameter specifies the number of vertices of the remeshed surface to be size*size. The program parameterizeGenus0 optionally receives a filename parameter to which the related remeshed surface model produced by step 250 is to be saved.

In this implementation, step 220 of FIG. 2 is performed by a procedure CutSurface, and step 230 of FIG. 2 is performed by a procedure DnCParameterize, which adopts divide and conquer strategy to flatten each open 3D surface into the unit disk x²+y²≦1 in the 2D parameter space. The two procedures CutSurface and DnCParameterize will be described later.

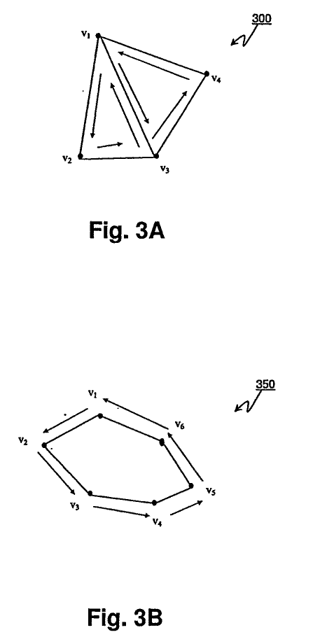

The surface is represented by standard directional triangle meshes, as shown in FIG. 3A, which is a schematic diagram representation of a triangular mesh 300 having vertices V₁, V₂, V₃ and V₄. The triangular mesh 300 consists of two triangles V₁V₂V₃ and V₁V₃V₄ which share a common boundary V₁V₃. The edge directions of a triangular mesh are indicated by arrows. The direction of each edge is specified so that the normal of each triangle of the surface points to the same side of the surface.

FIG. 3B is a schematic representation of a closed path 350 having vertices V₁V₂V₃V₄V₅V₆. The closed path of FIG. 3B will now be utilized in defining the cut of a surface. For two vertices v1 and v2, if there is a triangle edge from v1 to v2, then it is said that there is a directional path=v1v2 from v1 to v2. If there is a path1 from v1 to v2, and a path2 from v2 to v3, then it is said v1 and v3 have a path path1path2 from v1 to v3. When a closed surface is cut into two open surfaces, there are two directional closed paths along the cut that are the boundaries of the two open surfaces. One of the two directional closed paths along the cut is selected as the boundary. Returning to FIG. 3B, in the directional boundary V₁V₂V₃V₄V₅V₆, the path from V₂ to V₅ includes edges V₂V₃, V₃V₄ and V₄V₅, while the path from V₅ to V₂ includes edges V₅V₆, V₆V₁ and V₁V₂.

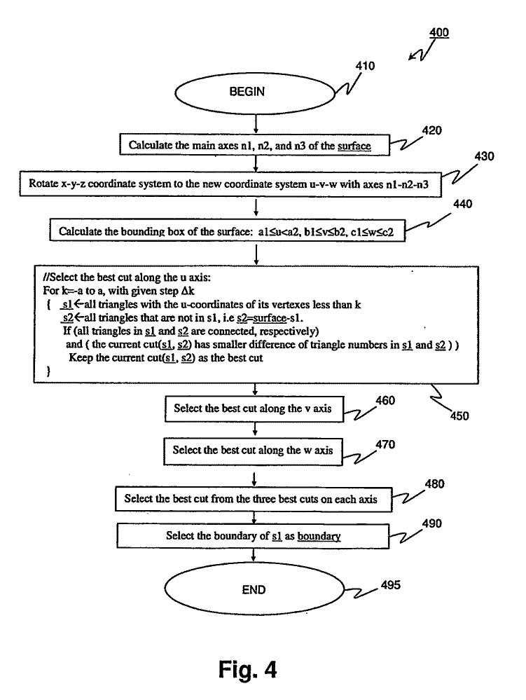

FIG. 4 is a flow diagram of the CutSuface procedure 400 corresponding to step 220 of FIG. 2. The procedure 400 begins at a BEGIN step 410 and proceeds to step 420, which calculates main axes n1, n2, and n3 of the surface using the principle component analysis method presented in “A tutorial on Principal Components Analysis”, Lindsay I Smith, http://www.cs.otago.ac.nz/cosc453/student_tutorials/principal_components.pdf. Control passes from step 420 to step 430, which rotates the Cartesian coordinate system of the surface to align with the three main axes n1, n2, and n3 identified in step 420. The new coordinate system is denoted as u-v-w. Control then passes to step 440, which calculates a1, a2, b1, b2, c1, and c2, which are the maximum and minimum values of coordinates u, v and w respectively. Thus, for each vertex of the surface, the coordinates (u, v, w) of the vertex satisfy: a1≦u≦a2, b1≦v≦b2, and c1≦w≦c2.

Control flows to step 450, which selects the best cut along the u axis. One method for determining the best cut is described below, but it will be appreciated by a person skilled in the art that other methods of selecting the best cut may equally be utilized. For example, the method presented in “Geometry Images”, X. Gu, et. al, SIGGRAPH 2002 Proceedings may equally be utilized.

For an index k ranging from a1 to a2, and with a given step Δk, perform the following steps:

1) All triangles within the triangle mesh of the given surface that have vertices with u-coordinates less than k are allocated to part s1.

2) All triangles within the triangle mesh of the given surface that are not in part s1 are allocated to part s2. This partition is denoted as cut(s1, s2).

3) If all triangles in s1 and s2 are connected, and the current cut(s1, s2) has a smaller difference of triangle numbers in s1 and s2, then keep the current cut(s1, s2) as the best cut.

Control passes from step 450 to step 460, which selects the best cut along the v axis, using a similar process to that described above in respect of the u axis in step 450. Step 470 then selects the best cut along the w axis, again using a similar process to that described above in respect of the u axis in step 450. In the embodiment described, steps 450, 460, and 470 are presented sequentially. However, it will be appreciated by a person skilled in the art that these steps may be performed in any order, and one or more of these steps may be performed in parallel.

Control passes to step 480 to select the best cut for the surface from the best cut for each respective axis u, v, and w. Control then passes to an END step 495.

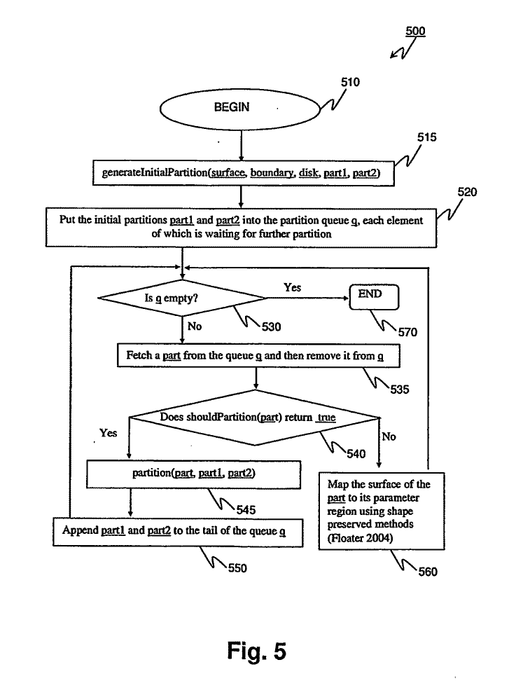

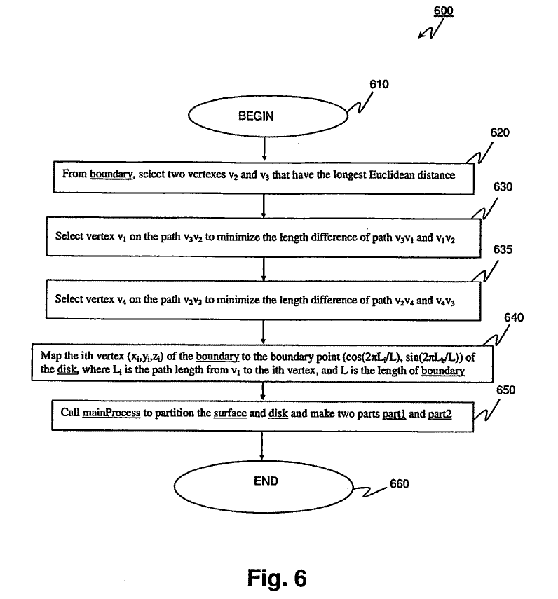

FIG. 5 is a flow diagram 500 of the control flow of a procedure DnCParameterize, which performs the functionality of step 230 of FIG. 2. The DnCParameterize procedure receives an open surface and an associated directional boundary, and uses the divide and conquer strategy to flatten the surface into the disk x²+y²≦1. The DnCParameterize procedure 500 starts at a BEGIN step 510 and proceeds to step 515, which receives the parameters surface, boundary, disk, part1, and part2 to generate an initial partition part1 and part2. The generation of the initial partition will be described below as the procedure generateInitialPartition with reference to FIG. 6. Control proceeds to step 520 that places initial partitions part1 and part2 into a partition queue q. Each element of the partition queue q is awaiting further partitioning. Control passes to a decision step 530 that determines whether the partition queue q is empty. If the partition queue q is empty, Yes, control passes to an END step 570 and the procedure terminates. If, however, at step 530 the partition queue q is not empty, No, control passes to step 535 that retrieves a partition part from the partition queue q, and then deletes the partition part from the partition queue q.

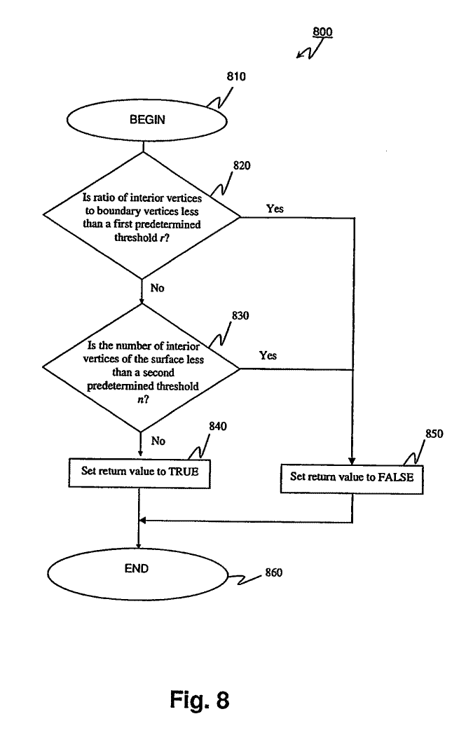

Control proceeds to decision step 540 to determine whether the retrieved partition part is to be further partitioned. The determination as to whether or not a partition is to be further partitioned will be described below as the procedure shouldPartition with reference to FIG. 8. If the partition is not to be partitioned, No, control passes from step 540 to step 560, which maps the surface of the partition part to a corresponding parameter region using shape preserved methods known to those skilled in the art, such as the method described in “Surface Parameterization: a Tutorial and Survey”, Floater M S and Hormann K (2004), Advances in Multiresolution for Geometric Modelling, Springer-Verlag, Heidelberg, 2004, at pages 157-186. Control returns from step 560 to decision step 530 to determine whether there are any more partitions in the queue.

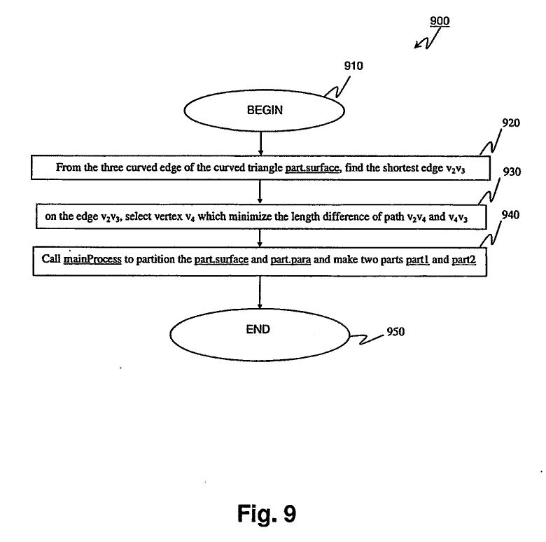

Returning to step 540, if the partition part is to be further partitioned, Yes, control passes to step 545. Step 545 partitions the partition part into patches part1 and part2. The implementation of the partitioning is described below with reference to FIG. 9. Control passes from step 545 to step 550, which appends each of the patches part1 and part2 returned from step 545 to the end of the partition queue q. Control then passes from step 550 to decision step 530, and the procedure continues until the queue q is empty.

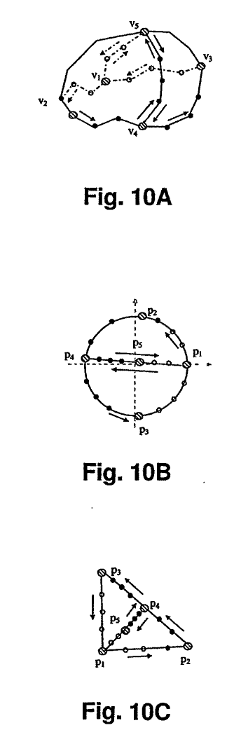

FIG. 6 is a flow diagram 600 of a procedure generateInitialPartition corresponding to the functionality of step 515 of FIG. 5. The generateInitialPartition procedure 600 receives an open surface, an associated directional boundary, and an initial disk (x²+y²≦1), and generates the initial partition of both the surface and the disk. The results are stored in parameters part1 and part2. The generateInitialPartition procedure 600 commences at a BEGIN step 610 and proceeds to step 620, which selects two vertices v₂ and v₃ having the longest Euclidean distances from the received parameter boundary. Control passes to step 630, which selects a vertex v₁ on the path v₃v₂ to minimize the difference in path lengths of the paths v₃v₁ and v₁v₂. Step 635 then selects a vertex v₄ on the path v₂v₃ to minimize the difference in path lengths of the paths v₂v₄ and v₄v₃. Steps 630 and 635 may be performed in any order, or in parallel. Further detail is provided below with reference to FIG. 10A.

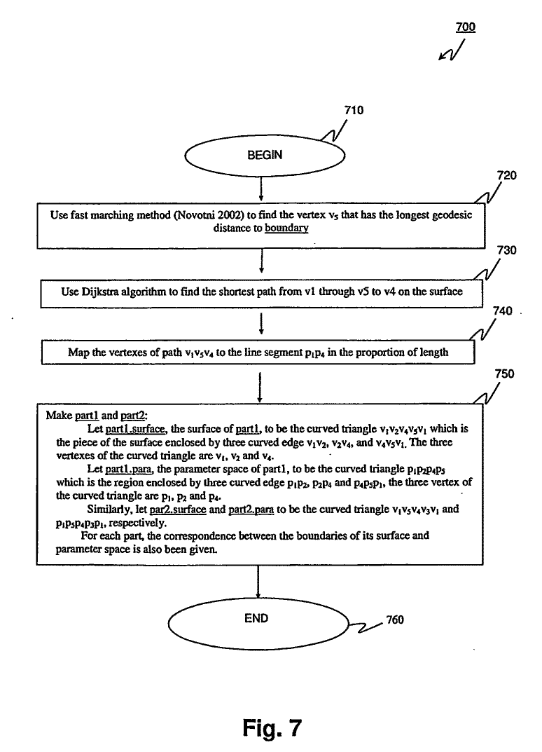

Control passes from step 635 to step 640, which maps the vertices of the boundary of the surface to the boundary point of the disk. In particular, the ith vertex (xᵢ, yᵢ, zᵢ) of the boundary is mapped to the boundary point (cos(2πLᵢ/l), sin(2πLₖ/L)) of the disk. Lᵢ is the path length from v₁ to the ith vertex, and L is the length of the boundary. Further detail is provided below with reference to FIG. 10B. A next step 650 partitions the surface and disk to generate two patches part1 and part2. The functionality of step 650 will be described below with reference to FIG. 7. Control passes from step 650 to an End step 660 and the generateInitialPartition procedure terminates.

FIG. 7 is a flow diagram 700 of a procedure mainProcess corresponding to the functionality of step 650 of FIG. 6. The procedure mainProcess 700 commences at a BEGIN step 710 and proceeds to step 720, which determines a vertex v₅ that has the longest geodesic distance to the boundary. Further detail is provided below with reference to FIG. 10A. In one embodiment, the fast marching method described in “Computing Geodesic Distances on Triangular Meshes”, Novotni M and Klein R (2002), in Proceeding of The 10-th International Conference in Central Europe on Computer Graphics, Visualization and Computer Vision (WSCG), pages 341-347, 2002, is used to determine the vertex v₅.

Control passes from step 720 to step 730, which utilizes the Dijkstra algorithm to determine the shortest path from vertex v₁ through the vertex v₅ to v₄ on the surface.

A next step 740 maps the vertices of path v₁v₅v₄ to a line segment p₁p₄ in the proportion of length. Control passes from step 740 to step 750, which generates the patches part1 and part2. The surface of part1, called part1.surface, is set to be the curved triangle v₁v₂v₄v₅v₁, which is the piece of the surface enclosed by three curved edges v₁v₂, v₂v₄, and v₄v₅v₁. The three vertices of the curved triangle are v₁, v₂, and v₄. The parameter space of part1, called part1.para, is set to be the curved triangle p₁p₂p₄p₅, which is the region enclosed by the three curved edges p₁p₂, p₂p₄, and p₄p₅p₁. The three vertices of the curved triangle are p₁, p₂, and p₄.

Similarly, the surface of part2, part2.surface, is set to be the curved triangle v₁v₅v₄v₃v₁, and the parameter of part2, part2.para, is set to be the curved triangle p₁p₅p₄p₃p₁. Control passes to an END step 760 and the procedure mainProcess terminates.

FIG. 8 is a flow diagram 800 of a procedure shouldPartition corresponding to the functionality of step 540 of FIG. 5. The procedure shouldPartition 800 commences at a BEGIN step 810 and proceeds to a first decision step 820 that determines whether a ratio of interior vertices to boundary vertices of a given surface part.surface is less than a first predetermined threshold r. If the ratio is not less than the first predetermined threshold, No, control passes to a second decision step 830 that determines whether the number of interior vertices is less than a second predetermined threshold n. If the number of interior vertices is not less than the second predetermined threshold, No, control passes to step 840 which sets a return value to TRUE. Control passes from step 840 to an END step 860, and the process terminates.

Returning to step 830, if the number of interior vertices is less than the second predetermined threshold, Yes, control passes to a step 850 that sets the return value to FALSE. Control passes from step 850 to the End step 860.

Returning to step 820, if the ratio is less than the first predetermined threshold, Yes, control passes from step 820 to the step 850 to set the return value to FALSE and the process terminates at the END step 860.

FIG. 9 is a flow diagram 900 of a procedure Partition corresponding to the functionality of step 545 of FIG. 5. The procedure Partition receives a parameter part that specifies a piece of a curved triangle surface partsuface and a corresponding curved triangle parameter space part.para. The procedure Partition partitions both part.surface and part.para to form two small parts part1 and part2. The procedure Partition 900 commences at a BEGIN step 910 and control passes to step 920 that determines a shortest edge v₂v₃ from three curved edges of the curved triangle part.surface. Having determined the shortest edge v₂v₃, control passes to step 930 that selects a vertex v₄ on the edge v₂v₃ such that the difference in path lengths v₂v₄ and v₄v₃ is minimized. A next step 940 utilizes the procedure mainProcess described above with reference to FIG. 7 to partition the part.surface and part.para to generate two patches part1 and part2. Control passes to step 950 and the procedure Partition terminates.

FIGS. 10A, 10B, and 10C illustrate the partitioning of a 3D surface and its corresponding parameter space. Directions of edges are indicated by arrows. FIG. 10A shows an original 3D surface patch in which a point v₅ has the longest geodesic distance to the boundary v₁v₂v₃v₄v₁. The conquer and divide strategy described above is used to map the boundary of the surface shown in FIG. 10A to the boundary of a corresponding parameter space. In an initial step of the procedure, corresponding to procedure generateInitialPartition of FIG. 6 described above, the parameter space is a unit disk, as shown in FIG. 10B. In the middle of the partitioning procedure, corresponding to procedure Partition of FIG. 9 described above, the parameter space is a curved triangle region, as shown in FIG. 10C. The cut paths v₁v₅v₄ and p₁p₅p₄ cut the surface into two parts, respectively.

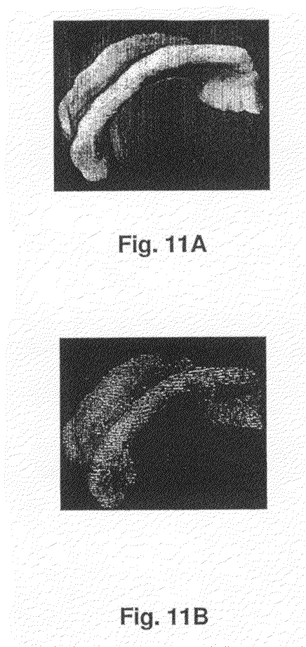

FIGS. 11A and 11B are 3D computer image representations of the corpus callosum, which is a broad, thick band running from one side of the human brain to another and consisting of nerve fibres. These images are generated from the Talairach-Toumoux brain atlas. FIG. 11A is a solid model representation, and FIG. 11B is a wireframe view.

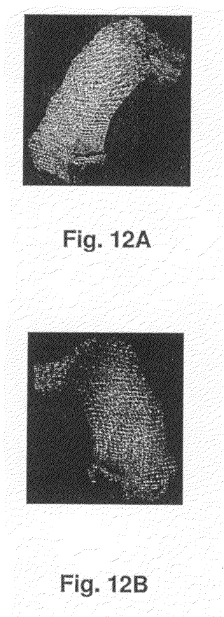

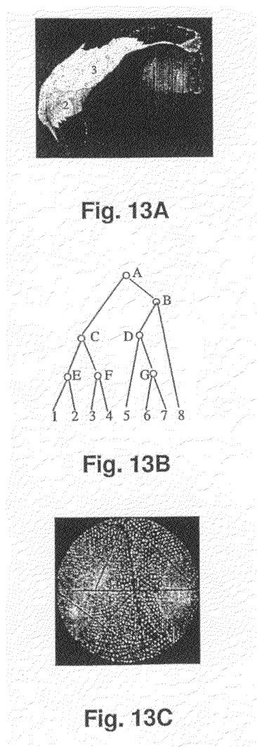

The 3D surface of the corpus callosum from FIG. 11B is cut into two open surfaces shown in FIGS. 12A and 12B, respectively, wherein FIG. 12A shows the left part and FIG. 12B shows the right part. The right part is further partitioned into 8 small patches indexed as 1 to 8 and shown in FIG. 13A. The partition of its corresponding parameter space is shown in FIG. 13C. The partition procedure is represented by a partition tree shown in FIG. 13B. The partition tree illustrates that the entire open surface shown in FIG. 13A and its corresponding parameter disk shown in FIG. 13C are first partitioned into two patches B and C, in which C includes patches 1,2,3,4, and B includes patches 5,6,7,8. Patch C is then partitioned into: (i) E including 1 and 2; and (ii) F including 3 and 4. Patch B is partitioned into: (i) 8; and (ii) D including 5 and G, wherein G includes 6 and 7.

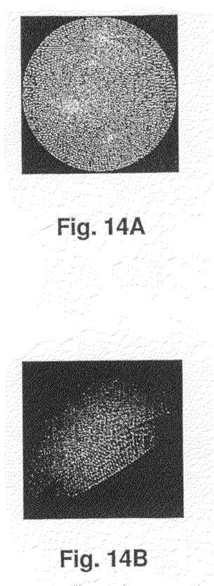

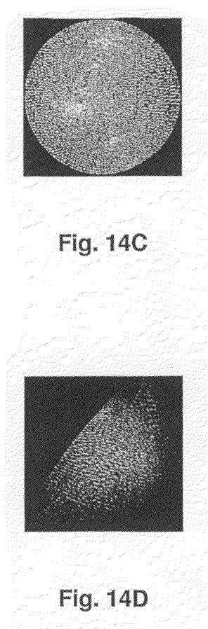

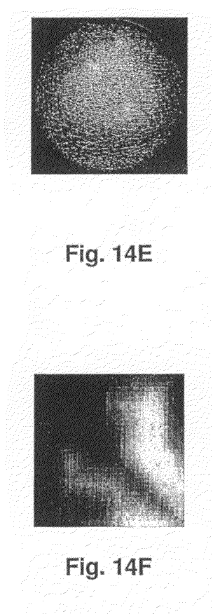

FIGS. 14A to 14F illustrate that the two parameter disks are combined to form a parameter sphere and to generate a geometrical image. FIG. 14A shows the parameter disk of the left part of FIG. 12A. FIG. 14B shows a mapping of the parameter disk of FIG. 14A into an upper hemi-sphere. FIG. 14C shows the parameter disk of the right part of FIG. 12B. FIG. 14D shows a mapping of the parameter disk of FIG. 14C into a lower hemi-sphere. The upper and lower hemi-spheres of FIGS. 14B and 14D are combined to form a single sphere, as shown in FIG. 14E. A geometrical image is then derived from the parameter sphere of FIG. 14E, as shown in FIG. 14F.

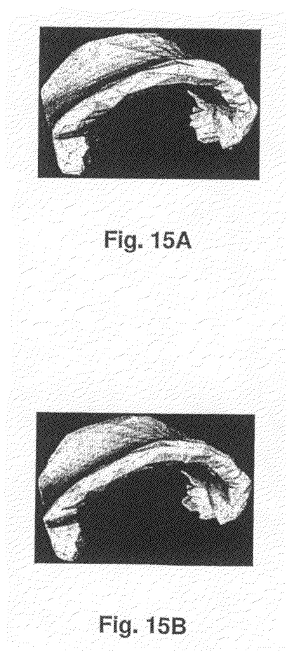

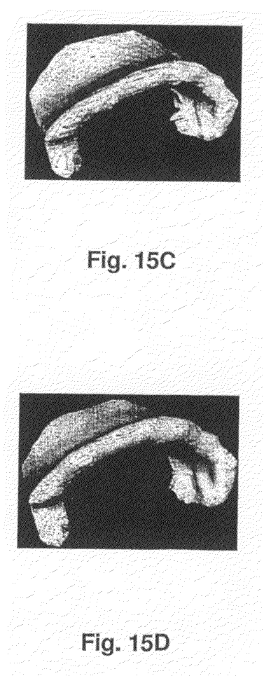

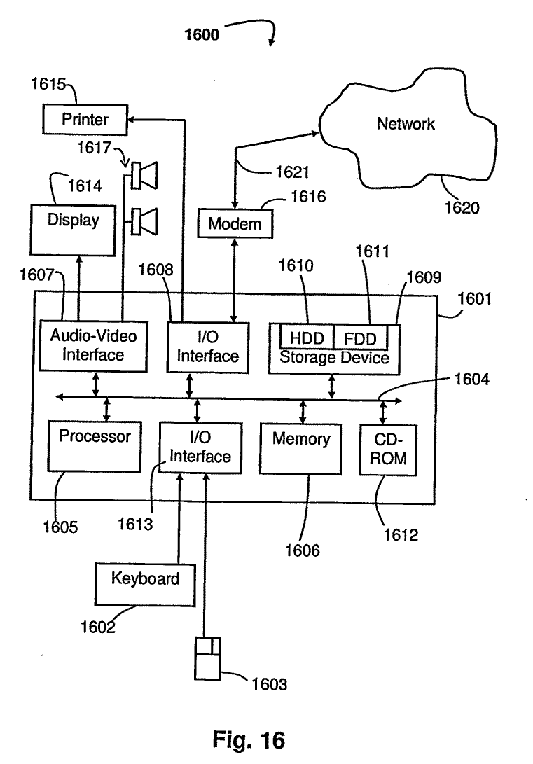

FIGS. 15A to 15D illustrate the remeshing of the parameter sphere of FIG. 14F to produce multi-resolution models of the corpus callosum of FIG. 11B. FIG. 15A is a 30×30 model, FIG. 15B is a 40×40 model, FIG. 15C is a 50×50 model, and FIG. 15D is a 100×100 model.

The aforementioned preferred method(s) comprise a particular control flow. There are many other variants of the preferred method(s) which use different control flows without departing from the spirit or scope of the invention. Furthermore one or more of the steps of the preferred method(s) may be performed in parallel rather than sequentially.

The method of surface parameterization is preferably practised using a general-purpose computer system 1600, such as that shown in FIG. 16 wherein the processes of FIGS. 2 to 10 may be implemented as software, such as an application program executing within the computer system 1600. In particular, the steps of the method of surface parameterization using a divide and conquer strategy are effected by instructions in the software that are carried out by the computer. The instructions may be formed as one or more code modules, each for performing one or more particular tasks. The software may also be divided into two separate parts, in which a first part performs the surface parameterization methods and a second part manages a user interface between the first part and the user. The software may be stored in a computer readable medium, including the storage devices described below, for example. The software is loaded into the computer from the computer readable medium, and then executed by the computer. A computer readable medium having such software or computer program recorded on it is a computer program product. The use of the computer program product in the computer preferably effects an advantageous apparatus for geometric modelling.

The computer system 1600 is formed by a computer module 1601, input devices such as a keyboard 1602 and mouse 1603, output devices including a printer 1615, a display device 1614 and loudspeakers 1617. A Modulator-Demodulator (Modem) transceiver device 1616 is used by the computer module 1601 for communicating to and from a communications network 1620, for example connectable via a telephone line 1621 or other functional medium. The modem 1616 can be used to obtain access to the Internet, and other network systems, such as a Local Area Network (LAN) or a Wide Area Network (WAN), and may be incorporated into the computer module 1601 in some implementations.

The computer module 1601 typically includes at least one processor unit 1605, and a memory unit 1606, for example formed from semiconductor random access memory (RAM) and read only memory (ROM). The module 1601 also includes an number of input/output (I/O) interfaces including an audio-video interface 1607 that couples to the video display 1614 and loudspeakers 1617, an I/O interface 1613 for the keyboard 1602 and mouse 1603 and optionally a joystick (not illustrated), and an interface 1608 for the modem 1616 and printer 1615. In some implementations, the modem 1616 may be incorporated within the computer module 1601, for example within the interface 1608. A storage device 1609 is provided and typically includes a hard disk drive 1610 and a floppy disk drive 1611. A magnetic tape drive (not illustrated) may also be used. A CD-ROM drive 1612 is typically provided as a non-volatile source of data. The components 1605 to 1613 of the computer module 1601, typically communicate via an interconnected bus 1604 and in a manner which results in a conventional mode of operation of the computer system 1600 known to those in the relevant art. Examples of computers on which the described arrangements can be practised include IBM-PC's and compatibles, Sun Sparcstations or alike computer systems evolved therefrom.

Typically, the application program is resident on the hard disk drive 1610 and read and controlled in its execution by the processor 1605. Intermediate storage of the program and any data fetched from the network 1620 may be accomplished using the semiconductor memory 1606, possibly in concert with the hard disk drive 1610. In some instances, the application program may be supplied to the user encoded on a CD-ROM or floppy disk and read via the corresponding drive 1612 or 1611, or alternatively may be read by the user from the network 1620 via the modem device 1616. Still further, the software can also be loaded into the computer system 1600 from other computer readable media. The term “computer readable medium” as used herein refers to any storage or transmission medium that participates in providing instructions and/or data to the computer system 1600 for execution and/or processing. Examples of storage media include floppy disks, magnetic tape, CD-ROM, a hard disk drive, a ROM or integrated circuit, a magneto-optical disk, or a computer readable card such as a PCMCIA card and the like, whether or not such devices are internal or external of the computer module 1601. Examples of transmission media include radio or infra-red transmission channels as well as a network connection to another computer or networked device, and the Internet or Intranets including e-mail transmissions and information recorded on Websites and the like.

The method of surface parameterization may alternatively be implemented in dedicated hardware such as one or more integrated circuits performing the functions or sub functions of dividing, conquering, and parameterization. Such dedicated hardware may include graphic processors, digital signal processors, or one or more microprocessors and associated memories.

### INDUSTRIAL APPLICABILITY

The arrangements disclosed herein are applicable to the computing industries. In particular, embodiments of the invention may be practised upon the construction of a multi-resolution 3D model represented by a geometric image that facilitates the storage and transmission of a large model with high accuracy. Such a model may be transmitted over a communications network, including the Internet. Arrangements can also be utilized to improve the speed of surface model manipulation software.

Further, an embodiment of the invention may be utilized to provide a deformable geometric model with controllable resolution and the required properties for model-based image segmentation and registration, automatic or semi-automatic cortical surface labelling.

Alternate embodiments may be utilized in the construction of solid and surface meshes for brain tissue finite element method (FEM) analysis.

One or more further embodiments of the invention may be utilized in the construction of an application programming interface (API), plugin component, or middleware for fast multi-resolution 3D model generation. Such applications are typically associated with 3D game and computer-aided design.

The foregoing describes only some embodiments of the present invention, and modifications and/or changes can be made thereto without departing from the scope and spirit of the invention, the embodiments being illustrative and not restrictive.

We claim:

1. A method of parameterizing a surface, said method comprising the steps of:
dividing a surface into first and second parts;
flattening said first and second parts to first and second disks, respectively;
combining said first and second disks to form a sphere; and
remeshing said sphere with a predetermined resolution to provide a multi-resolution structured surface model for said surface.

2. The method according to claim 1, wherein said surface is a genus-0 surface.

3. The method according to claim 1, wherein said division of said surface is arbitrary.

4. The method according to claim 1, wherein said division of said surface produces substantially equal first and second parts.

5. The method according to claim 1, wherein said flattening step utilizes a shape preserved method.

6. The method according to claim 1, wherein each of said first and second disks is defined by the equation x²+y²≦1.

7. The method according to claim 1, wherein a boundary of said first and second parts is mapped in said flattening step to a circle defined by the equation x²+y²=1.

8. The method according to claim 1, wherein said sphere is defined by the equation x²+y²+z²=1.

9. The method according to claim 8, wherein said first disk is mapped to z=\sqrt{(x²+y²)}.

10. The method according to claim 8, wherein said second disk is mapped to z=−\sqrt{(x²+y²)}.

11. The method according to claim 1, wherein said surface is presented as a triangular mesh.

12. The method according to claim 1, wherein said dividing step comprises the further steps of:
calculating first, second, and third main axes of the surface to determine a surface coordinate system;
rotating a Cartesian coordinate system to align with said surface coordinate system;
translating an origin point of said surface coordinate system to the centroid of said surface; and
selecting a best cut of said surface along at least one of said first, second, and third axes to determine said first and second parts.

13. The method according to claim 12, wherein said translating step establishes a bounding box of the surface for first, second, and third axes u, v, and w of said surface coordinate system, said bounding box defined by: a1≦u<a2, b1≦v<b2, c1≦w<c2,
wherein:
a1 and a2 are respective minimum and maximum values of coordinate u,
b1 and b2 are respective minimum and maximum values of coordinate v, and
c1 and c2 are respective minimum and maximum values of coordinate w.

14. The method according to claim 12, wherein said step of selecting a best cut of said surface along an axis comprises the steps of:
for an index k ranging from a minimum value to a maximum value of a coordinate of said axis, for a predetermined step Δk:
allocating to a first portion all triangles within a triangle mesh that have vertices with said axis coordinates less than k;
allocating to a second portion all triangles within said triangle mesh that are not in said first portion; and
defining said first and second portions as a best cut of said axis, if all triangles in said first and second portions are connected, and said first and second portions have a smaller difference of triangle numbers than an existing best cut.

15. The method according to claim 12, comprising the further step of:
selecting a respective best cut along each of said first, second, and third axes; and
selecting a best cut from said respective best cuts along said first, second, and third axes.

16. The method according to claim 1, wherein said flattening step comprises the steps of:
generating first and second partitions;
placing said first and second partitions into a queue of elements; and
while the queue is not empty:
retrieving an element from said queue;
determining whether said retrieved element is to be further partitioned;
mapping the surface of the retrieved element to a corresponding parameter region using a shape preserved method, when said retrieved element is not to be further partitioned; and
partitioning said retrieved element into first and second patches and appending said first and second patches to said queue, when said retrieved element is to be further partitioned.

17. The method according to claim 16, wherein said step of generating said first and second partitions comprises the steps of:
selecting second and third vertices (v2, v3) having longest Euclidean distances from a boundary of said surface;
selecting a first vertex (v1) on the path between said third and second vertices (v3v2), such that a difference in path lengths between said first and second vertices and said first and third vertices is minimized;
selecting a fourth vertex (v4) on the path between said second and third vertices, such that a difference in path lengths between said second and fourth vertices and said fourth and third vertices is minimized;
mapping the vertices of the boundary of the surface to a boundary point of a mapped disk; and
partitioning said surface and said mapped disk to form said first and second partitions.

18. The method according to claim 17, wherein said mapping step maps the ith vertex (xᵢ, yᵢ, zᵢ) of the boundary to a boundary point (cos(2πLᵢ/l), sin(2πLₖ/L)) of said mapped disk, wherein Lᵢ is the path length from the first vertex to the ith vertex, and L is the length of said boundary.

19. The method according to claim 17, wherein said partitioning comprises the steps of:
determining a fifth vertex having a longest geodesic distance to said boundary;
determining a shortest path from said first vertex through said fifth vertex to said fourth vertex on said surface;
mapping vertices along said shortest path to points in a line segment p1p4 of a corresponding parameter space in proportion of length;
defining a surface of a first partition to be a curved triangle v1v2v4v5v1, said surface of said first partition being enclosed by three curved edges v1v2, v2v4, and v4v5v1, wherein said first, second and fourth vertices are vertices of said curved triangle v1v2v3v5v1;
defining a parameter space of said first partition to be a curved triangle p1p2p4p5, said parameter space being a region enclosed by three curved edges p1p2, p2p4, and p4p5p1, wherein p1, p2, and p4 are vertices of said curved triangle p1p2p4p5;
defining a surface of a second partition to be a curved triangle v1v5v4v3v1; and
defining a parameter space of said second partition to be a curved triangle p1p5p4p3p1.

20. The method according to claim 19, wherein said fifth vertex is determined using a fast marching method.

21. The method according to claim 19, wherein said shortest path from said first vertex through said fifth vertex to said fourth vertex on said surface is determined using the Dijkstra algorithm.

22. The method according to claim 16, wherein said step of determining whether said retrieved element is to be further partitioned comprises the step of:
determining that further portioning of said retrieved element is required, when a ratio of the number of interior vertices to boundary vertices of a surface is greater than or equal to said first predetermined threshold and said number of interior vertices is less than a second predetermined threshold.

23. The method according to claim 16, wherein said step of partitioning said retrieved element comprises the further steps of:
determining a shortest edge v2v3 from three curved edges of a curved triangle;
selecting a vertex v4 on said shortest edge v2v3, wherein the difference in path lengths v2v4 and v4v3 is minimal; and
partitioning said surface and parameter space to generate said first and second patches.

24. The method according to claim 1, wherein said remeshing uses a spherical remeshing method.

25. Apparatus for parameterizing a surface, said apparatus comprising:
means for dividing a surface into first and second parts;
means for flattening each of said first and second parts to first and second disks, respectively;
means for combining said first and second disks to form a sphere; and
means for remeshing said sphere with a predetermined resolution to provide a multi-resolution structured surface model for said surface.

26. The apparatus according to claim 25, wherein said surface is a genus-0 surface.

27. The apparatus according to claim 25, wherein said means for dividing divides said surface arbitrarily.

28. The apparatus according to claim 25, wherein said means for dividing divides said surface into substantially equal first and second parts.

29. The apparatus according to claim 25, wherein said means for flattening utilizes a shape preserved method.

30. The apparatus according to claim 25, wherein said surface is presented as a triangular mesh.

31. The apparatus according to claim 30, wherein said means for dividing further comprises:
means for calculating first, second, and third main axes of the surface to determine a surface coordinate system;
means for rotating a Cartesian coordinate system to align with said surface coordinate system;
means for translating an origin point of said surface coordinate system to the centroid of said surface; and
means for selecting a best cut of said surface along at least one of said first, second, and third axes to determine said first and second parts.

32. The apparatus according to claim 31, wherein said means for translating establishes a bounding box of the surface for first, second, and third axes u, v, and w of said surface coordinate system, said bounding box defined by: a1≦u<a2, b1≦v<b2, c1≦w<c2,
wherein:
a1 and a2 are respective minimum and maximum values of coordinate u,
b1 and b2 are respective minimum and maximum values of coordinate v, and
c1 and c2 are respective minimum and maximum values of coordinate w.

33. The apparatus according to claim 31, further comprising:
means for selecting a respective best cut along each of said first, second, and third axes; and
means for selecting a best cut from said respective best cuts along said first, second, and third axes.

34. The apparatus according to claim 25, wherein said means for flattening further comprises:
means for generating first and second partitions;
means for placing said first and second partitions into a queue of elements;
means for retrieving an element from said queue;
means for determining whether said retrieved element is to be further partitioned;
means for mapping the surface of the retrieved element to a corresponding parameter region using a shape preserved method, when said retrieved element is not to be further partitioned; and
means for partitioning said retrieved element into first and second patches and appending said first and second patches to said queue, when said retrieved element is to be further partitioned.

35. The apparatus according to claim 34, wherein said means for generating said first and second partitions comprises:
means for selecting second and third vertices (v2, v3) having longest Euclidean distances from a boundary of said surface;
means for selecting a first vertex (v1) on the path between said third and second vertices (v3v2), such that a difference in path lengths between said first and second vertices and said first and third vertices is minimized;
means for selecting a fourth vertex (v4) on the path between said second and third vertices, such that a difference in path lengths between said second and fourth vertices and said fourth and third vertices is minimized;
means for mapping the vertices of the boundary of the surface to a boundary point of a mapped disk; and
means for partitioning said surface and said mapped disk to form said first and second partitions.

36. The apparatus according to claim 35, wherein said means for partitioning comprises:
means for determining a fifth vertex having a longest geodesic distance to said boundary;
means for determining a shortest path from said first vertex through said fifth vertex to said fourth vertex on said surface;
means for mapping vertices along said shortest path to points in a line segment plp4 of a corresponding parameter space in proportion of length;
means for defining a surface of a first partition to be a curved triangle v1v2v4v5v1, said surface of said first partition being enclosed by three curved edges v1v2, v2v4, and v4v5v1, wherein said first, second and fourth vertices are vertices of said curved triangle v1v2v3v5v1;
means for defining a parameter space of said first partition to be a curved triangle p1p2p4p5, said parameter space being a region enclosed by three curved edges p1p2, p2p4, and p4p5p1, wherein p1, p2, and p4 are vertices of said curved triangle p1p2p4p5;
means for defining a surface of a second partition to be a curved triangle v1v5v4v3v1; and
means for defining a parameter space of said second partition to be a curved triangle p1p5p4p3p1.

37. The apparatus according to claim 36, wherein said means for determining said fifth vertex utilizes a fast marching method.

38. The apparatus according to claim 36, wherein said means for determining said shortest path from said first vertex through said fifth vertex to said fourth vertex on said surface utilizes the Dijkstra algorithm.

39. The apparatus according to claim 36, wherein said means for determining whether said retrieved element is to be further partitioned comprises:
means for determining that further portioning of said retrieved element is required, when a ratio of the number of interior vertices to boundary vertices of a surface is greater than or equal to said first predetermined threshold and said number of interior vertices is less than a second predetermined threshold.

40. The apparatus according to claim 36, wherein said means for partitioning said retrieved element comprises:
means for determining a shortest edge v2v3 from three curved edges of a curved triangle;
means for selecting a vertex v4 on said shortest edge v2v3, wherein the difference in path lengths v2v4 and v4v3 is minimal; and
means for partitioning said surface and parameter space to generate said first and second patches.

41. The apparatus according to claim 25, wherein said means for remeshing utilizes a spherical remeshing method.

42. A computer program product having a computer readable medium having a computer program recorded therein for parameterizing a surface, said computer program product comprising:
computer program code means for dividing a surface into first and second parts;
computer program code means for flattening each of said first and second parts to first and second disks, respectively;
computer program code means for combining said first and second disks to form a sphere; and
computer program code means for remeshing said sphere with a predetermined resolution to provide a multi-resolution structured surface model for said surface.

43. A computer program for parameterizing a surface, said program comprising:
code for dividing a surface into first and second parts;
code for flattening each of said first and second parts to first and second disks, respectively; and
code for combining said first and second disks to form a sphere; and
code for remeshing said sphere with a predetermined resolution to provide a multi-resolution structured surface model for said surface.
